(19) United States
(12) Patent Application Publication
(10) Pub. No.: US 2020/0334119 A1
(43) Pub. Date: Oct. 22, 2020

(54) DATA PROCESSING SYSTEM AND OPERATING METHOD THEREOF

(71) Applicant: SK hynix Inc., Icheon (KR)

(72) Inventor: Min Soo LIM, Hwaseong (KR)

(21) Appl. No.: 16/689,016

(22) Filed: Nov. 19, 2019

(30) Foreign Application Priority Data
Apr. 17, 2019 (KR) 10-2019-0044976

(51) Int. Cl. G06F 11/30; G06F 11/32; G06F 1/3203

(52) U.S. Cl. CPC G06F 11/3037; G06F 1/3203; G06F 11/324; G06F 11/3062

(57) ABSTRACT

A data processing system may include a data processing group including a plurality of memory devices and a system controller configured to control a data input and output for the data processing group. The system controller may be configured to include a power management device configured to configure at least one memory group by grouping the plurality of memory devices based on a preset criterion and to determine a power mode of each of the memory groups based on whether a host device accesses each of the memory groups and an access interval.

### CROSS-REFERENCES TO RELATED APPLICATION

The present application claims priority under 35 U.S.C. § 119(a) to Korean application number 10-2019-0044976, filed on Apr. 17, 2019, in the Korean Intellectual Property Office, which is incorporated herein by reference in its entirety.

### BACKGROUND

### 1. Technical Field

Various embodiments generally relate to a semiconductor integrated device, and more particularly, to a data processing system and an operating method thereof.

### 2. Related Art

A circuit or device made of a semiconductor may be configured to transmit and receive electrical signals to and from other devices. For example, a semiconductor circuit or device is configured to compute or store a received signal and to transmit the stored or computed signal.

With an increase in demands for ubiquitous technologies for transmitting, analyzing, and processing a large amount of signals at high speed, such as for artificial intelligence, autonomous vehicles, and virtual reality, research is being carried out to develop techniques for maintaining signal processing performance of a semiconductor device while minimizing power consumption.

### SUMMARY

In an embodiment, a data processing system may include a data processing group comprising a plurality of memory devices and a system controller configured to control a data input and output for the data processing group and having a power management device, the power management device configured to: group the plurality of memory devices into one or more memory groups based on a preset criterion, and respectively determine a power mode of each memory group of the one or more memory group based on whether a host device accesses each of the memory groups during an access interval.

Embodiments further include an operating method of a data processing system, the data processing system including a data processing group comprising a plurality of memory devices and a system controller configured to control a data input and output for the data processing group, the operating method comprising: configuring, by the system controller, one or more memory groups by grouping the plurality of memory devices based on a preset criterion; determining, by the system controller, whether a host device accesses a memory group of the one or more memory groups; and controlling, by the system controller, power of the memory group based on whether the host device accesses the memory group within an access interval.

### BRIEF DESCRIPTION OF THE DRAWINGS

FIG. 1 illustrates an electronic system according to an embodiment.

FIG. 2 illustrates a data processing system according to an embodiment.

FIG. 3 illustrates a data processing device according to an embodiment.

FIG. 4 illustrates a system controller according to an embodiment.

FIG. 5 illustrates a power management device according to an embodiment.

FIG. 6 illustrates a system controller according to an embodiment.

FIG. 7 is a flowchart of an operating process of a data processing system according to an embodiment.

FIG. 8 is a flowchart of a memory grouping process according to an embodiment.

FIG. 9 illustrates a data processing system in accordance with an embodiment.

FIG. 10 illustrates a network system including a data storage device in accordance with an embodiment.

### DETAILED DESCRIPTION

Hereinafter, a data processing system and an operating method thereof will be described below in more detail with reference to the accompanying drawings through various examples of embodiments.

FIG. 1 illustrates an electronic system 10 according to an embodiment.

The electronic system 10 may include a data processing system 100 and a host device 200 communicating with the data processing system 100.

The host device 200 may transmit a request REQ, an address ADD, and data DATA, if necessary, related to data processing, to the data processing system 100. The data processing system 100 may perform an operation corresponding to the request REQ in response to the request REQ and address ADD of the host device 200, and may transmit data DATA to the host device 200, if necessary.

As the amount of data DATA transmitted and received between the data processing system 100 and the host device 200 increases and the host device 200 is implemented in a small device, such as a smartphone, a tablet PC or a notebook, the host device 200 may process a complicated operation using capabilities on the data processing system 100 (such as, for example, in cloud computing). That is, the data processing system 100 may be configured to autonomously compute the data DATA as well as simply storing or outputting data.

The data processing system 100 may include a high performance computing (HPC) device for performing a high-level operation in a cooperative way using a supercomputer or computer cluster or an array of networked information processing devices or servers for individually processing data.

The data processing system 100 may include a plurality of data processing devices for storing or computing data DATA and outputting the computed data DATA.

The data processing devices included in the data processing system 100 may include at least one server computer or at least one rack included in each of the server computers or at least one board included in each of the racks.

As described above, the data processing system 100 may include a plurality of data processing devices in order to improve information processing performance. The data processing devices may be electrically networked to transmit, receive, and/or share data between themselves.

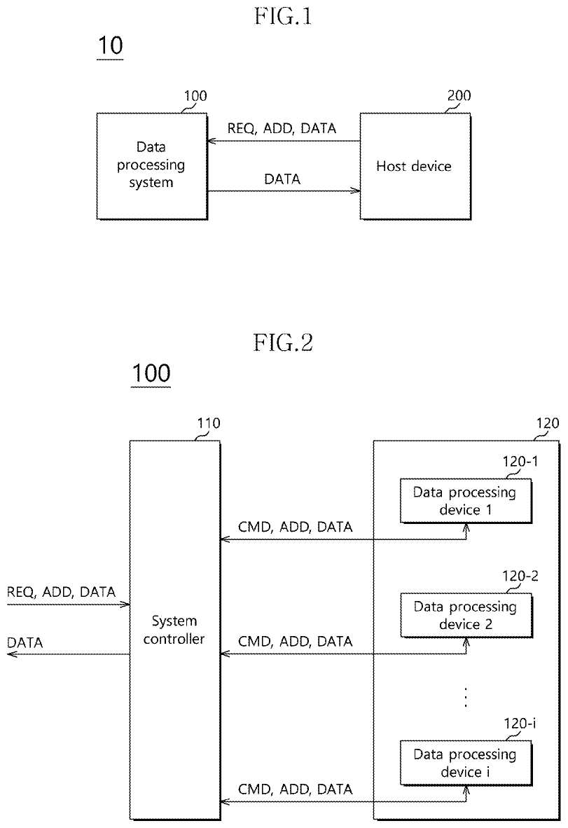

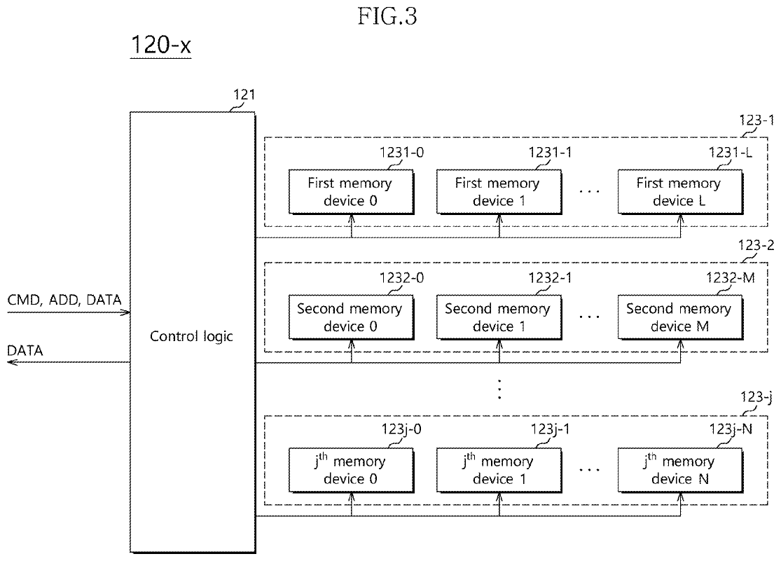

FIG. 2 illustrates the data processing system 100 according to an embodiment.

The data processing system 100 may include a system controller 110 and a data processing group 120. The data processing group 120 may include a plurality of data processing devices 120-1 and 120-2 to 120-i.

The system controller 110 is electrically coupled to the data processing group 120, and may control an overall operation of the data processing group 120 so that each of the data processing devices 120-1 to 120-i included in the data processing group 120 performs an operation of computing and/or storing data.

The system controller 110 may receive a request REQ and address ADD from the host device 200 or receive data DATA along with the request REQ and address ADD from the host device 200, and may generate a command CMD from the request REQ of the host device 200. The command CMD generated by the system controller 110 and the address ADD and/or the data DATA may be provided to the data processing group 120.

The data processing group 120 may operate in response to control of the system controller 110. In one embodiment, the data processing group 120 may process data in response to a command CMD from the system controller 110. Processing data may include an operation of reading data stored in a memory array within each of the data processing devices 120-1 to 120-i included in the data processing group 120, an operation of reading and performing a computation using the data, an operation of storing data provided by the system controller 110 in a memory array, or an operation of computing and storing the data provided by the system controller 110. Data processed by the data processing group 120 in response to a read request from the host device 200 may be provided to the host device 200 through the system controller 110.

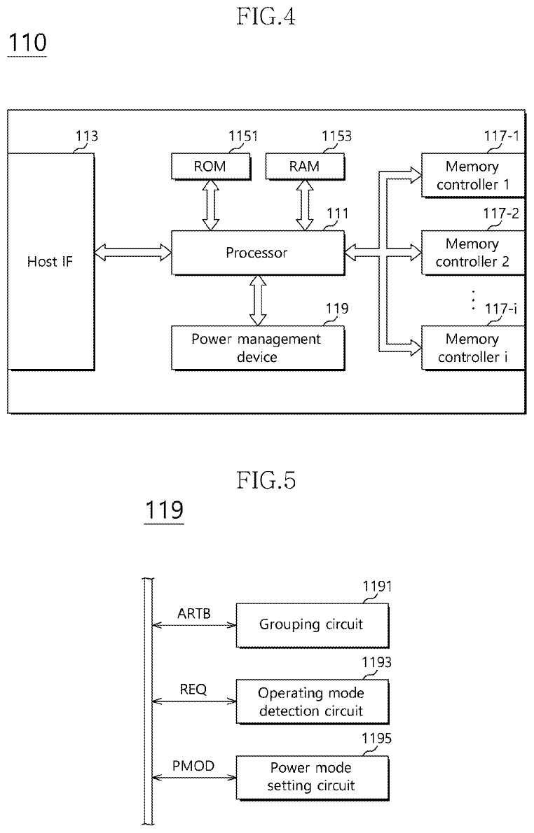

FIG. 3 illustrates a data processing device 120-x according to an embodiment.

The data processing device 120-x may include control logic 121 and a plurality of memory pools 123-1, 123-2, . . . , 123-j.

The memory pools 123-1, 123-2, . . . , 123-j may include a plurality of memory devices 1231-0 to 1231-L, 1232-0 to 1232-M, . . . , 123j0 to 123jN, respectively.

The control logic 121 may be configured to write data in each of the memory pools 123-1, 123-2, . . . , 123-j or read data from each of the memory pools 123-1, 123-2, . . . , 123-j in response to a command CMD and address ADD provided from the system controller 110 or in response to a command CMD, an address ADD and data DATA provided from the system controller 110.

In one embodiment, the data processing device 120-x may include an arithmetic circuit (not illustrated). The arithmetic circuit may perform an operation on data provided by the host device 200 or on data read from the memory devices 1231-0 to 1231-L, 1232-0 to 1232-M, . . . , 123j0 to 123jN, or both. The results of the operation may be provided to the host device 200 through the control logic 121 or may be stored in the memory devices 1231-0 to 1231-L, 1232-0 to 1232-M, . . . , 123j0 to 123j-N.

Referring to FIGS. 2 and 3, the data processing devices 120-1 to 120-i included in the data processing group 120 may include memory devices having the same or different types. Furthermore, the plurality of memory pools 123-1 to 123-j included in each of the data processing devices 120-1 to 120-i may include memory devices having the same or different types. Furthermore, the plurality of memory devices 1231-0 to 1231-L, 1232-0 to 1232-M, . . . , 123j0 to 123jN included in the memory pools 123-1, 123-2, . . . , 123-j, respectively, may include memory devices having the same or different types.

The type of memory device may be determined depending on a data storage technology or a data retention characteristic. In one embodiment, the data storage technology may use a process of storing charges or a process of changing a state of resistance. In one embodiment, the data retention characteristic may be a volatile characteristic in which data stored in the memory device may be lost when a power supply is cut or a non-volatile characteristic in which data is retained even when the power supply is cut.

Examples of a volatile memory device may include a dynamic random access memory (DRAM) and a static random access memory (SRAM).

Examples of a non-volatile memory device may include an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM).

The power consumption of a memory device may be different depending on the type (or kind) of the memory device. Accordingly, the system controller 110 may establish a power management policy by considering the type of the data processing devices 120-1 to 120-i, the type of the memory pools 123-1 to 123-j, or the type of the memory devices 1231-0 to 1231-L, 1232-0 to 1232-M, . . . , 123j0 to 123jN that make up the data processing group 120.

FIG. 4 illustrates the system controller 110 according to an embodiment.

The system controller 110 may include a processor 111, a host interface (IF) 113, a ROM 1151, a RAM 1153, a plurality of memory controllers 117-1 to 117-i, and a power management device 119.

The processor 111 may provide various functions for enabling the system controller 110 to manage the data processing group 120. In one embodiment, the processor 111 may control the host IF 113 and the memory controllers 117-1 to 117-i to process a write or read command provided by the host device 200. The processor 111 may be a central processing unit (CPU).

The processor 111 may perform an address mapping and management function in order to coordinate a logical address used by the host device 200 with a physical address used in the data processing group 120.

The processor 111 may manage the attributes of each of the plurality of data processing devices 120-1 to 120-i, the plurality of memory pools 123-1 to 123-j, and the plurality of memory devices 1231-0 to 1231-L, 1232-0 to 1232-M, . . . , 123j0 to 123jN, which make up the data processing group 120.

The host IF 113 may provide an interface between the host device 100 and the system controller 110. The host IF 113 may store and schedule a command provided by the host device 200 and provide the command to the processor 111. The host IF 113 may provide the memory controllers 117-1 to 117-i with write data provided by the host device 200 or provide the host device 200 with data provided through the memory controllers 117-1 to 117-i from the data processing group 120, under the control of the processor 111.

In an embodiment, the memory controllers 117-1 to 117-i may be respectively provided in the data processing devices 120-1 to 120-i that make up the data processing group 120.

The memory controllers 117-1 to 117-i may transmit data, provided by the host IF 113 to the data processing group 120 or may receive data read by the data processing group 120 and provide the received data to the host IF 113, under the control of the processor 111. To this end, the memory controllers 117-1 to 117-i may provide a communication channel for transmitting and receiving signals between the system controller 110 and the data processing group 120.

The ROM 1151 may store program codes used to perform operations of the system controller 110, for example, firmware or software, and may store data used by those operations.

The RAM 1153 may store data used by the operations of the system controller 110 or data generated by the system controller 110.

The data processing group 120 may include the plurality of data processing devices 120-1 to 120-i. Each of the data processing devices 120-1 to 120-i may include the plurality of memory pools 123-1 to 123-j. The memory pools 123-1, 123-2, . . . , 123-j may include the plurality of memory devices 1231-0 to 1231-L, 1232-0 to 1232-M, . . . , 123j0 to 123jN, respectively. Accordingly, power consumption of the data processing group 120 may increase in proportion to the number of memory devices 1231-0 to 1231-L, 1232-0 to 1232-M, . . . , 123j0 to 123jN. Furthermore, a temperature of the data processing system 100 may rise due to heat generated from the memory devices 1231-0 to 1231-L, 1232-0 to 1232-M, . . . , 123j0 to 123jN because of the increased power consumption. As a result, operational expenses may be incurred to lower the temperature and to provide for the increased power consumption.

The power management device 119 may group the memory devices 1231-0 to 1231-L, 1232-0 to 1232-M, . . . , 123j0 to 123jN within the data processing group 120 into memory groups based on a preset criterion, and may control power consumption of each of the memory groups. In one embodiment, the power management device 119 may group the memory devices 1231-0 to 1231-L, 1232-0 to 1232-M, . . . , 123j0 to 123jN within the data processing group 120 into memory groups based on a type (i.e., a volatile/non-volatile type). Furthermore, the power management device 119 may determine a power mode of the memory devices 1231-0 to 1231-L, 1232-0 to 1232-M, . . . , 123j0 to 123jN included in the data processing system 100 based on an address ADD inputted from the host device 200, that is, the use state (or access aspect) of the host device 200 for the data processing system 100. In one embodiment, the access aspect of the host device 200 may be determined based on an address inputted from the host device 200, and may include whether the host device 200 accesses the data processing system 100 during an access interval.

In one embodiment, the memory devices 1231-0 to 1231-L, 1232-0 to 1232-M, . . . , 123j0 to 123jN included in the data processing system 100 may include homogeneous or heterogeneous memory devices. The power management device 119 may group the memory devices 1231-0 to 1231-L, 1232-0 to 1232-M, . . . , 123j0 to 123jN into memory groups based on the type thereof, and may manage power of the memory devices based on the use state of the host device 200 for the grouped memory devices.

For example, at least one of the plurality of memory pools 123-1 to 123-j may include a volatile memory device. The volatile memory device may be a DRAM, for example. For example, at least one of the plurality of memory pools 123-1 to 123-j may include a non-volatile memory device. The non-volatile memory device may be a NAND flash memory device or a phase-change memory device, for example.

The power management device 119 may group the memory devices 1231-0 to 1231-L, 1232-0 to 1232-M, . . . , 123j0 to 123jN into memory groups according to whether each is a volatile memory device or a non-volatile memory device, that is, based on a data retention characteristic according to whether power is supplied.

In one embodiment, the power management device 119 may group the memory devices 1231-0 to 1231-L, 1232-0 to 1232-M, . . . , 123j0 to 123jN into memory groups based on a type, and may determine a power mode of each of the groups by determining an operating mode of each of the memory devices 1231-0 to 1231-L, 1232-0 to 1232-M, . . . , 123j0 to 123jN based on the access aspect of the host device for each of the groups, such as whether the host device accesses each of the groups and an access interval.

Operating modes of a memory group may include an inactive mode, a performance mode, and an idle mode, but embodiments are not limited thereto. The inactive mode may be a mode in which an access request from the host device is not present. The performance mode may be a mode in which a response is provided at high speed, that is, with low latency, in response to a request from the host device. A mode in which an additional access by the host device to the memory group occurs while the memory group waits without entering an idle state for a given period after a prior access of the host device to the memory group may be called a first performance mode. A mode in which the memory group enters an idle state because an additional access by the host device to the memory group did not occur within a given period after the prioaccess of the host device may be called a second performance mode.

The idle mode may be a mode in which the memory group enters an idle state immediately after a response to a request from the host device.

Accordingly, the power management device 119 may determine a power mode based on an operating mode of memory devices making up each of the memory groups.

In one embodiment, if a memory group including volatile memory devices is in the inactive mode, the power management device 119 may place the memory group in a first power saving mode. The first power saving mode may be a self-refresh mode, that is, a maximum idle mode of a volatile memory device, such as a DRAM.

If a memory group including volatile memory devices is in the first performance mode, the power management device 119 may place the memory group in a normal power mode. The normal power mode may be a mode in which power defined in a standard is supplied without any attempt at saving the power. If a memory group including volatile memory devices is in the second performance mode, the power management device 119 may place the memory group in a second power saving mode. The second power saving mode may be a mode characterized by a power consumption that is lower than the power consumption of the normal power mode and higher than power consumption of the first power saving mode. The second power saving mode may be an active mode or a precharge mode in the case of a volatile memory device, such as a DRAM.

If a memory group including non-volatile memory devices is in an inactive state, the power management device 119 may place the memory group in the first power saving mode. In this case, the first power saving mode may be a power off mode or power gating mode in which a power supply to the memory group is cut.

In one embodiment, the power management device 119 may configure a to primary memory group by first grouping the memory devices 1231-0 to 1231-L, 1232-0 to 1232-M, . . . , 123j0 to 123jN that make up the data processing group 120 based on a type. In addition, the power management device 119 may configure a secondary memory group by grouping the memory devices belonging to the primary memory group based on an operating voltage characteristic, and may determine a power mode of the secondary memory group based on an access aspect of the host device for the memory devices belonging to the secondary memory group.

The memory devices 1231-0 to1231-L, 1232-0 to 1232-M, . . . , 123j0 to 123jN may be tested through speed binning for identifying a relation between an operating voltage and an operating speed after fabrication, and may be classified based on operating voltage characteristics. A specific memory device may operate at a speed faster than a speed defined in a standard if a voltage defined in the standard is applied to the specific memory device. Such a memory device may provide a required performance when a voltage lower than the voltage defined in a standard is supplied to the memory device.

Minimum operating voltage information (e.g., an operating voltage lower bound) of each of the memory devices 1231-0 to 1231-L, 1232-0 to 1232-M, . . . , 123j0 to 123jN for each operation frequency may be obtained through speed binning. The minimum operating voltage information may be stored in a specific region of the memory devices 1231-0 to 1231-L, 1232-0 to 1232-M, . . . , 123j0 to 123jN (such as in a Serial Presence Detect (SPD) device of a memory module) or may be physically marked on the memory devices 1231-0 to 1231-L, 1232-0 to 1232-M, . . . , 123j0 to 123jN. If the memory pools 123-1 to 123-j and the data processing device 120-x are configured using the memory devices 1231-0 to 1231-L, 1232-0 to 1232-M, . . . , 123j0 to 123jN in which operating voltage information has been stored or marked, the system controller 110 may receive the operating voltage information from a user and store the received operating voltage information or may read the operating voltage information from a specific region of the memory devices 1231-0 to 1231-L, 1232-0 to 1232-M, . . . , 123j0 to 123jN upon booting.

Accordingly, the power management device 119 may secondarily group the memory devices 1231-0 to 1231-L, 1232-0 to 1232-M, . . . , 123j0 to 123jN based on operating voltage information of the memory devices 1231-0 to 1231-L, 1232-0 to 1232-M, . . . , 123j0 to 123jN.

In one embodiment, the power management device 119 may configure a to plurality of primary memory groups by primarily grouping the memory devices 1231-0 to 1231-L, 1232-0 to 1232-M, . . . , 123j0 to 123jN based on a type. Furthermore, the power management device 119 may configure a secondary memory group by secondarily grouping the memory devices belonging to each of the primary memory groups based on a plurality of preset operating voltage ranges. Furthermore, the power management device 119 may determine a maximum value of operating voltage lower bounds of the memory devices 1231 to 1˜1231-L, 1232-0 to 1232-M, . . . , 123j0 to 123jN belonging to a secondary memory group as a normal operating voltage of the secondary memory group.

The power management device 119 may classify memory devices into a primary memory group, may classify the memory devices of the primary memory group into a secondary memory group, and then may determine a power mode of the secondary memory group based on an access aspect of the host device with respect to the secondary memory group.

FIG. 5 illustrates the power management device 119 according to an embodiment.

The power management device 119 may include a grouping circuit 1191, an operating mode detection circuit 1193 and a power mode setting circuit 1195.

The grouping circuit 1191 may receive, from the processor 111, attribute information ARTB for each of the memory devices 1231-0 to 1231-L, 1232-0 to 1232-M, . . . , 123j0 to 123jN, included in the memory pools 123-1, 123-2, . . . , 123-j, respectively, included in the data processing devices 120-1 to 120-i within the data processing group 120, and may configure a memory group by grouping the memory devices 1231-0 to 1231-L, 1232-0 to 1232-M, . . . , 123j0 to 123jN based on a preset criterion.

In one embodiment, the attribute information ARTB may include a volatile/non-volatile memory attribute indicative of a data retention characteristic depending on whether power is supplied to each of the memory devices 1231-0 to 1231-L, 1232-0 to 1232-M, . . . , 123j0 to 123jN, and may further include operating voltage information in addition to the volatile/non-volatile memory attribute.

The grouping circuit 1191 may group the memory devices 1231-0 to 1231-L, 1232-0 to 1232-M, . . . , 123j0 to 123jN into primary memory groups by volatile memory device and/or by non-volatile memory device based on such attribute information ARTB. Furthermore, the grouping circuit 1191 may group memory devices in each primary group into secondary memory groups by grouping the memory devices 1231-0 to 1231-L, 1232-0 to 1232-M, . . . , 123j0 to 123jN in each primary memory group based on a plurality of preset operating voltage ranges of the memory devices.

The operating mode detection circuit 1193 may determine an operating mode (e.g., inactive mode, performance mode, or idle mode) of the memory devices 1231-0 to 1231-L, 1232-0 to 1232-M, . . . , 123j0 to 123jN, belonging to a memory group, based on the address ADD of the host device 200 for the data processing system 100.

In one embodiment, the inactive mode may be a mode in which an access request from the host device is not present.

The performance mode may be a mode in which a response to a request from the host device is provided at high speed, that is, with low latency. The performance mode may include a first performance mode and a second performance mode. The first performance mode may be a mode in which an additional access by the host device occurs while a memory group waits without entering an idle state for a given period after a most-recent access by the host device. The second performance mode may be a mode in which a memory group enters an idle state because an additional access by the host device did not occur for the given period after the most-recent access by the host device.

The idle mode may be a mode in which the memory group enters an idle state immediately after providing a response to a request from the host device.

In response to the operating mode detection circuit 1193 determining an operating mode of each primary or secondary memory group, the power mode setting circuit 1195 may be configured to determine a power mode PMOD of each memory group and output the determined power mode.

In one embodiment, the power mode setting circuit 1195 may place a memory group in a first power saving mode if a memory group including volatile memory devices is determined to be in the inactive mode. For volatile memory devices, the first power saving mode may be a self-refresh mode, that is, a maximum idle mode of a volatile memory device, such as a DRAM.

If a memory group including volatile memory devices is in the first performance mode, the power mode setting circuit 1195 may place the memory group in a normal power mode. The normal power mode may be a mode in which power defined in a standard is supplied without any attempt to save power. If a memory group configured with volatile memory devices is in the second performance mode, the power mode setting circuit 1195 may place the memory group in a second power saving mode. The second power saving mode may be a mode having power consumption that is lower than power consumption of the normal power mode and higher than power consumption of the first power saving mode. The second power saving mode may be an active mode or a precharge mode in the case of a volatile memory device, such as a DRAM.

If a memory group including non-volatile memory devices is in an inactive state, the power mode setting circuit 1195 may place the memory group in the first power saving mode. For non-volatile memory devices, the first power saving mode may be a power off mode or power gating mode in which a power supply to the memory group is cut.

A secondary memory group grouped based on minimum operating voltage information, among the memory groups of volatile or non-volatile memory devices primarily grouped by the grouping circuit 1191, may operate in the first performance mode, for example. Furthermore, the secondary memory group operating in the first performance mode may be controlled in a third power saving mode. In one embodiment, the third power saving mode may be a mode in which a maximum value of operating voltage lower bounds of the memory devices belonging to the secondary memory group is supplied as an operating voltage to the memory devices of the secondary memory group.

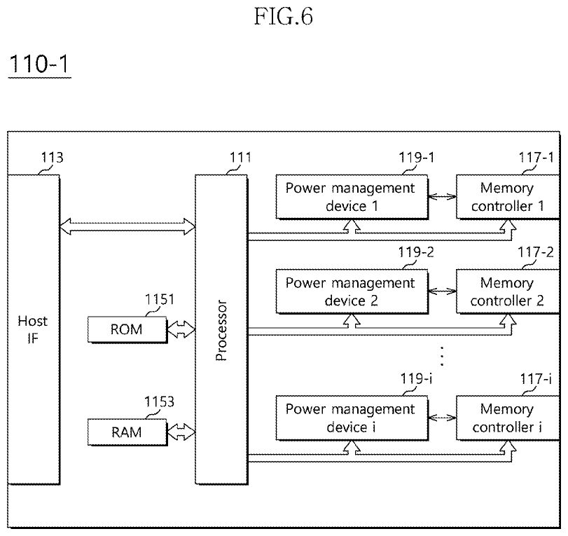

FIG. 6 illustrates the configuration of a system controller 110-1 according to an embodiment.

The system controller 110-1 of FIG. 6 is different from the system controller 110 of FIG. 4 in that it includes respective power management devices 119-1 to 119-i for the memory controllers 117-1 to 117-i of each of the data processing devices 120-1 to 120-i.

Each of the power management devices 119-1 to 119-i may determine a power mode of each of the memory devices 1231-0 to 1231-L, 1232-0 to 1232-M, . . . , 123j0 to 123jN of the memory pools 123-1, 123-2, . . . , 123-j, included in each of the data processing devices 120-1 to 120-i, through each of the memory controllers 117-1 to 117-i. That is, power management device 119-1 may determine a power mode for each of the memory devices included in the data processing devices 120-1, power management device 119-2 may determine a power mode for each of the memory devices included in the data processing devices 120-2, and so on.

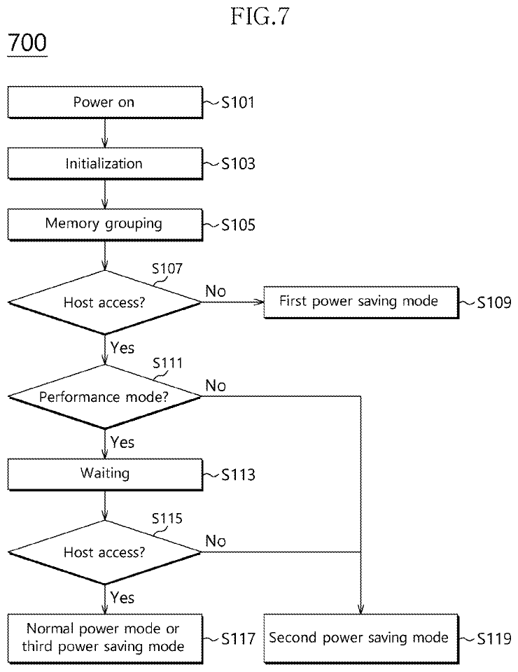

FIG. 7 is a flowchart illustrating an operating process 700 of a data processing system according to an embodiment.

Power may be supplied to the electronic system 10 (S101), and thus the data processing system 100 and the host device 200 may be booted and initialized (S103).

The power management device 119 (or each of the power management devices 119-1 through 119-i of FIG. 6) of the system controller 110 (or of the system controller 110-1) may group the memory devices 1231-0 to 1231-L, 1232-0 to 1232-M, . . . , 123j0 to 123jN into memory groups based on attribute information ARTB for each of the memory devices 1231-0 to 1231-L, 1232-0 to 1232-M, . . . , 123j0 to 123jN included in the data processing group 120 (S105).

In one embodiment, the attribute information ARTB may include a volatile/non-volatile memory attribute indicative of a data retention characteristic depending on whether power is supplied to each of the memory devices 1231-0 to 1231-L, 1232-0 to 1232-M, . . . , 123j0 to 123jN. The attribute information ARTB may further include operating voltage information of the memory devices 1231-0 to 1231-L, 1232-0 to 1232-M, . . . , 123j0 to 123jN in addition to the volatile/non-volatile memory attribute.

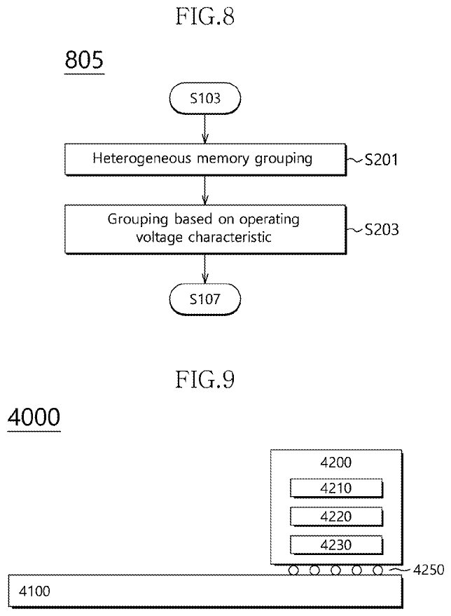

FIG. 8 is a flowchart illustrating a memory grouping process 805 according to an embodiment. The memory grouping process 805 may be performed at S105 of the process 700 of FIG. 7.

As illustrated in FIG. 8, the system controller 110 (or 110-1) may group the memory devices 1231-0 to 1231-L, 1232-0 to 1232-M, . . . , 123j0 to 123jN into primary memory groups by volatile memory device and/or by non-volatile memory device based on the volatile/non-volatile attribute information of the attribute information ARTB (S201). Furthermore, the system controller 110 (or 110-1) may group the memory devices in one or more of the primary memory groups into one or more secondary memory groups according to the operating voltage information for each memory device included in the attribute information ARTB (S203).

Referring back to FIG. 7, the system controller 110 (or 110-1) may determine an operating mode (e.g., inactive mode, performance mode or idle mode) of each of the memory devices 1231-0 to 1231-L, 1232-0 to 1232-M, . . . , 123j0 to 123jN, grouped as the memory group at step S105, based on the address ADD provided from the host device 200 to the data processing system 100.

Specifically, for each memory group, if an access request having an address ADD corresponding to a memory group has not been received from the host device (S107: No), the system controller 110 (or 110-1) may determine that an operating mode of the memory devices 1231-0 to 1231-L, 1232-0 to 1232-M, . . . , 123j0 to 123jN within the memory group is the inactive mode. As a result, the system controller 110 (or 110-1) may place the memory devices of the memory group in the inactive mode in the first power saving mode (S109). In an embodiment, an access request having an address ADD corresponding to the memory group is determined to not have been received from the host if such an access request has not been received during an access interval.

In one embodiment, if a memory group in the inactive mode includes volatile memory devices, the first power saving mode may be a self-refresh mode. If a memory group in the inactive mode includes non-volatile memory devices, the first power saving mode may be a power off mode or a power gating mode.

For each memory group, if an access request from the host device is present for the memory group (S107: Yes), the system controller 110 (or 110-1) may determine whether the memory group is in the performance mode (S111). If it is determined that the memory group is not in the performance mode (S111: No), the corresponding to memory group may operate in the second power saving mode (S119).

The performance mode may be a mode in which a response to a request from the host device is provided at high speed, that is, with low latency.

If a memory group not in the performance mode includes volatile memory devices, the second power saving mode may be a mode characterized by having a power consumption higher than the power consumption in the first power saving mode, and may be an active mode or a precharge mode in the case of a DRAM.

If the memory group operates in the performance mode (S111: Yes), the memory group may wait without entering an idle state for a given (pre-determined) period (i.e., a waiting time) after each access by the host device (S113). When an additional access of the host device occurs during the given period (S115: Yes), the system controller 110 (or 110-1) may determine that the memory group operates in the first performance mode.

The system controller 110 (or 110-1) may place a memory group that has been determined to operate in the first performance mode in the normal power mode or a third power mode.

In one embodiment, the system controller 110 (or 110-1) may place each of memory groups of volatile/non-volatile memory devices grouped at step S105 that are determined to be in the first performance mode in the normal power mode.

In another embodiment, in addition to the primary grouping of the volatile/non-volatile memory devices into primary groups at step S105, the volatile/non-volatile memory devices within each primary memory group may be grouped into secondary memory groups on operating voltage information. When a secondary memory group having a characteristic in that the memory devices can operate at a voltage lower than a voltage defined in a standard while still meeting a pre-determined performance criteria, the second memory group may be placed in a third power saving mode. The third power saving mode may be a mode in which a maximum value of operating voltage lower bounds of the memory devices of the secondary memory group is supplied to the memory devices in the secondary memory group as an operating voltage.

If additional access of the host device does not occur during the waiting time of step S113 (S115: No), the system controller 110 (or 110-1) may determine that the memory group operates in the second performance mode and may place the memory group in a second power saving mode (S119).

As described above, through use of this technology, power consumption and a temperature can be lowered by controlling the power mode of each of volatile memory devices and non-volatile memory devices. For example, if one or more volatile memory devices are not currently in use in the electronic system, they may be placed in the self-refresh mode in which data stored in the volatile memory devices can be retained. Furthermore, if one or more non-volatile memory devices are not currently in use in the electronic system, a power supply to those non-volatile memory devices can be cut because data stored in the non-volatile memory devices can be retained even though operation power to the devices is cut.

FIG. 9 is a diagram illustrating a data processing system 4000 in accordance with an embodiment. Referring to FIG. 9, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may include the features of the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

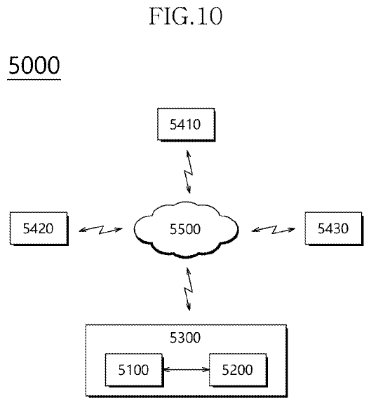

FIG. 10 is a diagram illustrating a network system 5000 including a data storage device, in accordance with an embodiment. Referring to FIG. 10, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may include features of the memory system 10 shown in FIG. 1 or of the memory system 4200 shown in FIG. 9.

While various embodiments have been described above, it will be understood to those skilled in the art that the embodiments described are examples only. Accordingly, the system and method described herein should not be limited based on the described embodiments.

What is claimed is:

1. A data processing system, comprising:
a data processing group comprising a plurality of memory devices; and
a system controller configured to control a data input and output for the data processing group and having a power management device,
wherein the power management device is configured to:
group the plurality of memory devices into one or more memory groups based on a preset criterion, and
respectively determine a power mode of each memory group of the one or more memory group based on whether a host device accesses each of the memory groups during an access interval.

2. The data processing system of claim 1, wherein the power management device is configured to group volatile memory devices of the plurality of memory devices as a memory group.

3. The data processing system of claim 2, wherein the power management device is configured to place the memory group in a first power saving mode when the memory group is determined to be in an inactive mode, the memory group being determined to be in the inactive mode when the host device does not access the memory group.

4. The data processing system of claim 2, wherein the power management device is configured to place the memory group in a second power saving mode when the memory group is not operating in a performance mode, the memory group is determined not to be operating in a performance mode when the memory group responds with greater than a threshold latency to an access of the host device.

5. The data processing system of claim 2, wherein the power management device is configured to:
determine that an operating mode of the memory group is a performance mode when the memory group responds with a threshold latency or less to an access of the host device,
determine that an operating mode of the memory group operating in the performance mode is a first performance mode in response to the memory group being accessed by the host device again within a threshold time after a previous access of the host device to the memory group, and
place the memory group in the first performance mode in a normal power mode.

6. The data processing system of claim 2, wherein the power management device is configured to:
determine that an operating mode of the memory group is a performance mode when the memory group responds with preset latency or less to an access of the host device,
determine that an operating mode of a memory group operating in the performance mode is a second performance in response to the memory group not being accessed by the host device within a preset time after the access of the host device, and
place the memory group in the second performance mode in a second power saving mode.

7. The data processing system of claim 1, wherein the power management device is configured to group non-volatile memory devices of the plurality of memory devices as a memory group.

8. The data processing system of claim 7, wherein the power management device is configured to:
determine an operating mode of the memory group as an inactive mode when the memory group is not accessed by the host device, and
place the memory group in the inactive mode in a power off mode.

9. The data processing system of claim 1, wherein:
the system controller is provided with an operating voltage lower bound of each of the plurality of memory devices, and
the power management device is configured to:
configure one or more primary memory groups by grouping the plurality of memory devices based on whether data stored in each of the plurality of memory devices is volatile, and
configure one or more secondary memory groups by grouping the memory devices included in each of the primary memory groups based on respective operating voltage lower bounds of the memory devices.

10. The data processing system of claim 9, wherein the power management device is configured to:
determine an operating mode of a secondary memory group of the one or more secondary memory groups as a performance mode when the secondary memory group responds with a threshold latency or less to an access of the host device,
determine an operating mode of the secondary memory group operating in the performance mode is a first performance mode in response to the second memory group being accessed by the host device again within a threshold time after a previous access of the host device to the second memory group, and
place the secondary memory group in the first performance mode in a third power mode.

11. An operating method of a data processing system, which includes a data processing group comprising a plurality of memory devices and a system controller configured to control a data input and output for the data processing group, the operating method comprising:
configuring, by the system controller, one or more memory groups by grouping the plurality of memory devices based on a preset criterion;
determining, by the system controller, whether a host device accesses a memory group of the one or more memory groups; and
controlling, by the system controller, power of the memory group based on whether the host device accesses the memory group within an access interval.

12. The operating method of claim 11, wherein configuring the one or more memory groups comprises grouping volatile memory devices of the plurality of memory devices as the memory group.

13. The operating method of claim 12, wherein controlling the power further comprises placing the memory group in a first power saving mode when the memory group is determined to be in an inactive mode, the memory group being determined to be in the inactive mode when the host device does not access the memory group.

14. The operating method of claim 12, wherein controlling the power further comprises placing the memory group in a second power saving mode when the memory group is determined to not be operating in a performance mode, the memory group being determined to not be operating in the performance mode when the memory group responds with greater than a threshold latency to an access of the host device.

15. The operating method of claim 12, wherein controlling the power further comprises:
determining an operating mode of the memory group is a performance mode when the memory group responds with a preset latency or less to an access of the host device,
determining the operating mode of the memory group operating in the performance mode is a first performance mode in response to the memory group being accessed by the host device again within a preset time after a previous access of the host device to the memory group, and
placing the memory group in the first performance mode in a normal power mode.

16. The operating method of claim 12, wherein controlling the power further comprises:
determining an operating mode of the memory group is a performance mode when the memory group responds with a preset latency or less to an access of the host device,
determining an operating mode of the memory group in the performance mode is a second performance mode in response to the memory group not being accessed by the host device within a preset time after the access of the host device, and
placing the memory group in the second performance mode in a second power saving mode.

17. The operating method of claim 11, wherein the configuring of the one or more memory groups comprises grouping non-volatile memory devices of the plurality of memory devices as the memory group.

18. The operating method of claim 17, wherein controlling of power further comprises:
determining an operating mode of the memory group as an inactive mode in response to the memory group not being accessed by the host device, and
placing the memory group in the inactive mode in a power off mode.

19. The operating method of claim 11, wherein the configuring of the memory group comprises:
receiving, by the system controller, an operating voltage lower bound of each of the plurality of memory devices,
configuring, by the system controller, one or more primary memory groups by grouping the plurality of memory devices based on whether data stored in the plurality of memory devices is respectively volatile, and
configuring one or more secondary memory groups by grouping the memory devices included in each of the primary memory groups based on the operating voltage lower bound.

20. The operating method of claim 19, wherein controlling of power further comprises:
determining an operating mode of a secondary memory group as a performance mode when the memory group responds with a preset latency or less to an access of the host device,
determining an operating mode of a secondary memory group in the performance mode as a first performance mode when the secondary memory group is accessed by the host device again within a preset time after a previous access of the host to device to the secondary memory group, and
placing the secondary memory group in the first performance mode in a third power mode.
